(19) United States
(12) Patent Application Publication
(10) Pub. No.: US 2024/0133108 A1
(43) Pub. Date: Apr. 25, 2024

(54) WASHER BASE

(71) Applicant: Sonoco Development, Inc., Hartsville, SC (US)

(72) Inventor: Clifton Moore, Murfreesboro, TN (US)

(73) Assignee: Sonoco Development, Inc., Hartsville, SC (US)

(21) Appl. No.: 17/969,772

(22) Filed: Oct. 19, 2022

(51) Int. Cl. D06F 39/00; B31B 50/62; B65D 81/05; B65D 85/68

(52) U.S. Cl. CPC D06F 39/001; B31B 50/622; B65D 81/053; B65D 85/68; B31B 2105/00; B65D 2585/6855

(57) ABSTRACT

A washer base used to support components of a washing machine or other large household appliance, particularly the centralized load elements, during assembly, shipping and handling by restricting their movement is provided.

### BACKGROUND OF THE INVENTION

### Field of the Invention

This invention relates to protective packaging for large appliances. More particularly, this invention solves the problem of providing support for the centralized load of an appliance during transport.

### Description of the Related Art

Top-loading washing machines generally comprise a spin or wash tub located within a washing machine cabinet or housing. The tub itself is suspended from the cabinet by suspension rods. Some washing machines have a center pivoting agitator extending upwardly from the bottom of the wash tub and operably connected to a motor located below the tub. Other washing machines lack this center agitator and instead have ridges located on the inside of the wash tub to assist with the agitating function. In washing machines without the center agitator, an agitator motor typically is suspended from the underside of the wash tub so that the tub itself may oscillate up and down and/or rotate back and forth to agitate and clean the clothes. In either type of washing machine, and in other large appliances, the motor and/or other components that are suspended from or located under the wash tub may be referred to as the “centralized load.”

Washing machines and other large household appliances typically are assembled while being carried on a base. At some point in the assembly process the centralized load is installed from underneath the cabinet, typically by lifting up or tilting the cabinet. Then the appliance is placed back on the base and assembly continues. The base may remain with the appliance after assembly and during shipping.

Washing machine bases made of EPS can break apart during impact. Corrugated base options exist, but they can be too bulky to fit inside a narrow cabinet opening. The present invention addresses these problems.

Some washing machines are relatively open at their bottom ends and their centralized load are surrounded by a large space. The cabinet may have a one to two inch inwardly extending bottom lip. These machines provide relatively easy access to the centralized load.

Other washing machines have an inwardly extending bottom lip that is up to five inches wide, which reduces access to the cabinet interior. Also, some washing machines have various protrusions and other oddly shaped structures located within the cabinet interior near the centralized load, resulting in an irregularly shaped space around the centralized load and reduced access to the centralized load. The washer base described herein is designed to accommodate such geometries.

### BRIEF SUMMARY OF THE INVENTION

The present disclosure relates to a washer base used to support components of a washing machine or other large household appliance, particularly the centralized load elements, during assembly, shipping and handling by restricting their movement.

In one aspect the disclosure relates to a washer base comprising a bottom panel and a center insert. The bottom panel has a top surface and defines a bottom opening having a polygonal first perimeter. The bottom panel further comprises bottom flaps hingedly connected to and extending upwardly from the first perimeter. The center insert rests on and extends upwardly from the top surface. The center insert has a polygonal bottom rim, a top rim and a sidewall affixed to the bottom flaps. The center insert may be shaped like a truncated pyramid, and may comprise a plurality of sidewall panels. Each sidewall panel has a top edge, a bottom edge and at least one side edge. At least one side panel has a second free end. Each sidewall panel is foldably connected to at least one other sidewall panel by the at least one side edge. The first perimeter comprises a number of fold lines joined together at an equal number of first nodes, and the bottom rim comprises a number of bottom edges joined together at second nodes.

In a refinement, the number of sidewall panels is eight, the number of fold lines and bottom edges is eight and the number of bottom flaps is eight.

In another refinement, the center insert further comprises a glue flap comprising a side edge and a second free edge. The glue flap may be foldably connected to a sidewall panel by a side edge. The glue flap overlaps a sidewall panel and is adhered thereto. In another refinement, the bottom panel comprises two sets of opposing bottom panel edges. Foam attachments are fitted securely onto at least one of the two sets of opposing edges.

In another aspect the disclosure relates to a method of using a washer base comprising the steps of:
(a) providing a washing machine comprising a cabinet affixed to a base, the base defining an opening, the washing machine further comprising a centralized load suspended below a wash tub and within the cabinet; and
(b) positioning the washer base under the washing machine so that the central insert fits between the centralized load and the cabinet.

The method of use may comprise the further step of securely fitting foam attachments onto opposing edges of the bottom panel.

In still another aspect the disclosure relates to a method of assembling a washer base comprising the steps of:
(a) providing a first blank formed from a substantially rectangular piece of corrugated and having a perimeter defined by four bottom panel edges, the blank comprising a top surface, a bottom opening having an octagonal first perimeter formed from eight fold lines, the blank further comprising a bottom flap hingedly connected to at least two of the fold lines;
(b) providing a second blank having a first free edge and free side edge, the second blank comprising eight substantially identical sidewall panels, each sidewall panel having a top edge, a bottom edge and two side edges, each sidewall panel foldably connected to at least one other sidewall panel along a common side edge, one of the sidewall panels having a side edge coinciding with the second free end, the second blank further comprising a glue flap having a bottom edge, a top edge and two side edges, the glue flap foldably connected to a sidewall panel by a common side edge, one of the side edges of the glue flap coinciding with the first free end;
(c) folding the second blank along each side edge to form a truncated eight sided pyramid structure with the glue flap overlapping an adjacent sidewall panel;
(d) adhering or otherwise affixing the glue flap to the adjacent sidewall panel to form an assembled center insert having a top rim and a bottom rim;
(e) positioning the center insert on top of the first blank so that the bottom rim coincides with the first perimeter;
(f) positioning each bottom flap against a corresponding sidewall panel or against the glue flap; and
(g) adhering each bottom flap to the corresponding sidewall panel or to the glue flap.

### BRIEF DESCRIPTION OF THE DRAWINGS

FIG. 1 is a perspective view of a washer base according to an aspect of the invention, the washer base comprising a bottom panel and a center insert.

FIG. 2 is an exploded view of the washer base of FIG. 1.

FIG. 3 is a top plan view of the washer base of FIG. 1.

FIG. 4 is a perspective view of the washer base of FIG. 1 shown with foam attachments.

FIG. 5 is a bottom perspective view of the washer base of FIG. 1 shown being installed under a washing machine.

FIG. 6 is a top plan view of a blank for making the bottom panel of FIG. 1.

FIG. 7 is a top plan view of a blank for making the center insert of FIG. 1.

### DETAILED DESCRIPTION OF THE INVENTION

While the invention described herein may be embodied in many forms, there is shown in the drawings and will herein be described in detail one or more embodiments with the understanding that this disclosure is to be considered an exemplification of the principles of the invention and is not intended to limit the disclosure to the illustrated embodiments. Aspects of the different embodiments can be combined with or substituted for one another.

As will be appreciated, terms such as “above” and “below”, “upper” and “lower”, “top” and “bottom,” “front” and “back,” (etc.), used as nouns, adjectives or adverbs refer in this description to the orientation of the structure of the wrapper as it is illustrated in the cross sectional views. Such terms are not intended to limit the invention to a particular orientation.

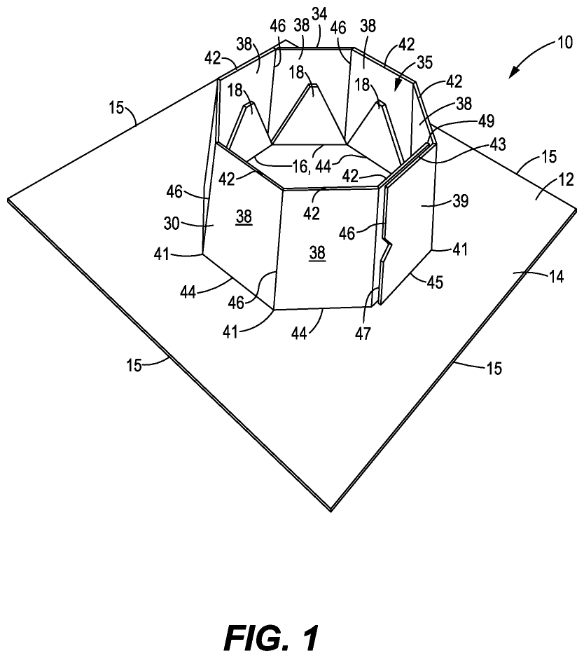

Turning to the drawings, where like numerals indicate like elements, there is shown in FIG. 1 one embodiment of the present invention, a washer base 10 that fits in a very narrow cabinet opening and secures a centralized load, rendering it motionless during transit. The washer base 10 comprises a bottom panel 12 and a center insert 30. The center insert 30 rests on and extends upwardly from the bottom panel 12.

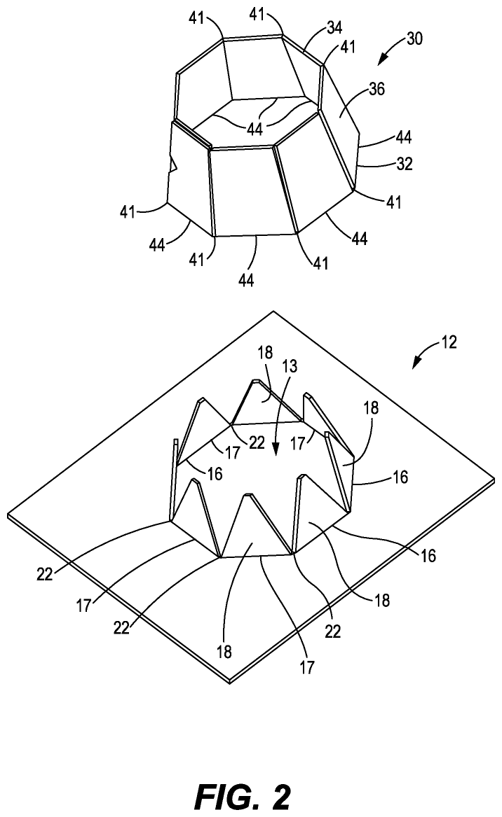

FIG. 2 is an exploded view of the washer base 10 of FIG. 1, showing the bottom panel 12 and the center insert 30 in more detail. The bottom panel 12 may be any suitable shape, such as rectangular, and may have a perimeter defined by two sets of opposing bottom panel edges 15. The bottom panel 12 also comprises a top surface 14 and defines a bottom opening 13 having a first perimeter 16. The bottom opening 13 has a polygonal bottom opening 13 that preferably is octagonal. The bottom panel 12 further comprises bottom flaps 18 hingedly connected to and extending upwardly from the first perimeter 16. The bottom flaps 18 may be triangular or any suitable shape.

The center insert 30 has a bottom rim 32, a top rim 34 and a multiplanar sidewall 36 which, in the assembled washer base 10, is affixed to the bottom flaps 18. The center insert 30 may be a lofted structure, that is, a structure having a smaller diameter at the top than at the bottom. For example, the center insert 30 may be truncated eight sided pyramid structure with a top rim 34 having a smaller diameter than the bottom rim 32. The bottom rim 32 may comprise a number of bottom edges 44 joined together at second nodes 41.

The sidewall 36 may comprise any suitable number of sidewall panels 38. In a preferred embodiment the number of sidewall panels 38 is eight.

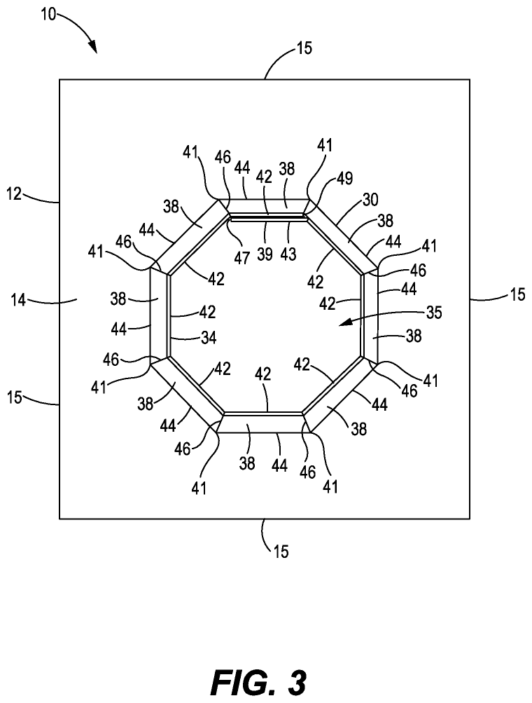

FIG. 3 is a top plan view of the washer base 10 of FIG. 1. The top rim 34 of the center insert 30 defines an octagonal shaped center opening 35 into which a centralized load 58 can fit. Because of the lofted shape of the center insert 30, the center opening 35 is smaller than the bottom opening 13 in the bottom panel 12.

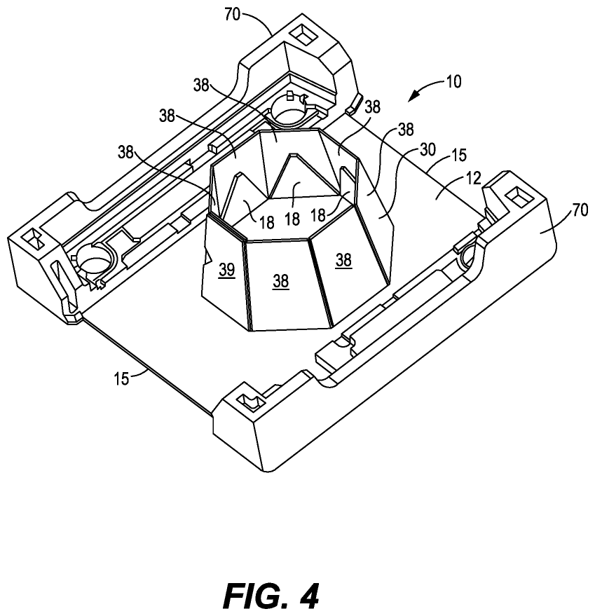

FIG. 4 is a perspective view of the washer base 10 of FIG. 1 shown with optional foam attachments 70. The foam attachments 70 fit securely onto opposing edges 15 of the bottom panel 12 and are designed to hold the washing machine 50 during storage and shipping.

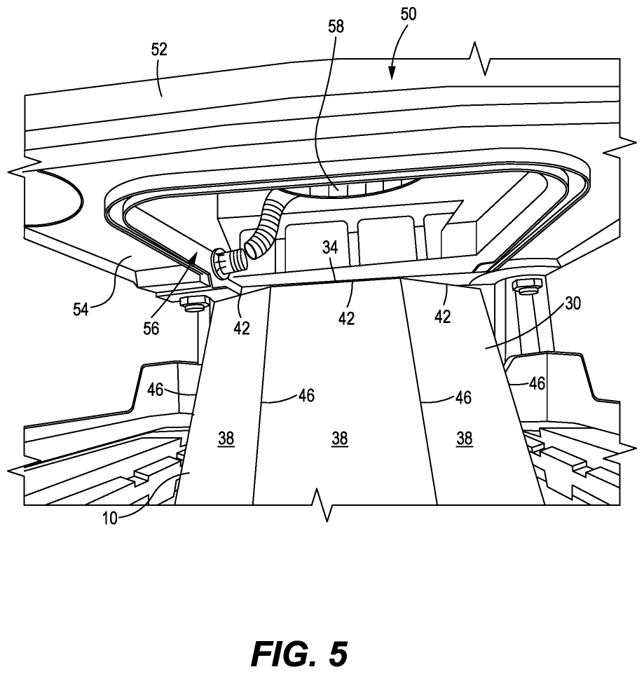

FIG. 5 is a bottom perspective view of the washer base 10 of FIG. 1 shown being installed under a washing machine 50. The washing machine 50 comprises a cabinet 52 resting on a base 54. The base 54 defines an opening 56 into which the washer base 10 can be inserted. A centralized load 58, such as a motor, is suspended below the wash tub (not shown) and within the cabinet 52. The washer base 10 and, more particularly, the center insert 30, is configured to fit between the centralized load 58 and the cabinet 52 to stabilize the centralized load 58, that is, prevent it from moving, or at least prevent it from impacting the inside walls of the cabinet 52.

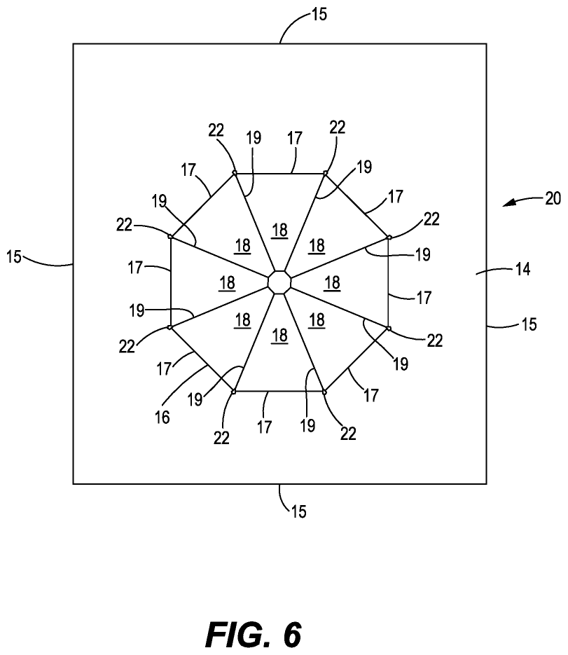

FIG. 6 is a top plan view of a first blank 20 for making the bottom panel 12 of FIG. 1. The blank 20 may be a substantially rectangular piece of corrugated paper-based material having a perimeter defined by four edges 15. In the embodiment illustrated in FIG. 6, the blank 20 comprises a top surface 14, a centrally located bottom opening 13 having a first perimeter 16 formed from eight fold lines 17, the first perimeter 16 also comprising eight first nodes 22, each first node 22 located at a junction of two fold lines 17. The blank 20 further comprises a substantially triangular bottom flap 18 hingedly connected to each fold line 17, each bottom flap 18 formed partly from two cut lines 19 that converge inwardly, each cut line 19 extending inwardly from a first node 22. The cut lines 19 form the sides of each bottom flap 18.

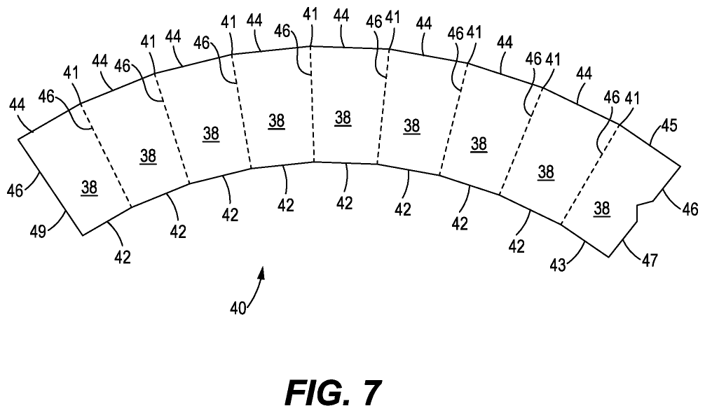

FIG. 7 is a top plan view of a second blank 40 for making the center insert 30 of FIG. 1. The second blank 40 may comprise eight substantially identical sidewall panels 38 and a glue flap 39 foldably connected in sequence along side edges 46. Each sidewall panel 38 has a top edge 42, a bottom edge 44, and two side edges 46 and may be shaped like a trapezoid in that the top edge 42 may be parallel to but shorter than the bottom edge 44. Similarly, the glue flap 39 may have a bottom edge 45, a top edge 43 and two side edges 46. Each sidewall panel 38 is foldably connected to at least one other sidewall panel 38 by a common side edge 46. The glue flap 39 is foldably connected to a sidewall panel 38 by a common side edge 46, the other side edge 46 of the glue flap 39 being a first free end 47. A sidewall panel 38 opposite the glue flap 39 in the sequence has a side edge 46 that is also a second free end 49.

### Alternative Embodiments

The bottom opening 13 may have a first perimeter 16 shaped like any suitable regular polygon, including, for example, a hexagon or a heptagon. Likewise, the number of sidewall panel 38 of the center insert 30 may be equal to the number of fold lines 17 forming the first perimeter 16.

### Method of Assembly

In another aspect of the invention a method of assembling a washer base 10 is provided. The method may comprise the steps of:
(a) providing a first blank 20 formed from a substantially rectangular piece of corrugated and having a perimeter defined by four edges 15, the blank 20 comprising a top surface 14, a bottom opening 13 having a first perimeter 16 formed from eight fold lines 17, the first perimeter 16 also comprising eight first nodes 22, each first node 22 located at a junction of two fold lines 17, the blank 20 further comprising a substantially triangular bottom flap 18 hingedly connected to each fold line 17, each bottom flap 18 having two cut lines 19 that converge inwardly, each cut line 19 extending inwardly from a node 22;
(b) providing a second bank 40 having a first free end 47 and a second free end 49, the second blank 40 comprising eight substantially identical trapezoidal sidewall panels 38, each sidewall panel 38 having a top edge 42, a bottom edge 44, and two side edges 46, each sidewall panel 38 foldably connected to at least one other sidewall panel 38 along a common side edge 46, one of the sidewall panels 38 having a side edge 46 coinciding with the second free end 49, the second blank 40 further comprising a glue flap 39 having a top edge 43, a bottom edge 45 and two side edges 46, the glue flap 39 foldably connected to a sidewall panel 38 by a common side edge 46, one of the side edges 46 of the glue flap 39 coinciding with the first free end 47;
(c) folding the second blank 40 along each side edge 46 to form a truncated eight sided pyramid structure with the glue flap overlapping a sidewall panel 38;
(d) adhering the glue flap 39 to the adjacent sidewall panel 38 to form an assembled center insert 30 having a top rim 34 and a bottom rim 32;
(e) positioning the center insert 30 on top of the first blank 20 so that the bottom rim 32 coincides with the first perimeter 16;
(f) positioning each bottom flap 18 against a corresponding sidewall panel 38 or against the glue flap 39; and
(g) adhering each bottom flap 18 to the corresponding sidewall panel 38 or to the glue flap 39.

### Method of Use

In another aspect of the invention a method of using a washer base 10 is provided. The method of use may comprise the steps of:
(a) providing an assembled washer base 10;
(b) providing a washing machine 50 comprising a cabinet 52 resting on a base 54, the base 54 defining an opening 56, the washing machine further comprising a centralized load 58 suspended below a wash tub and within the cabinet 52; and
(c) positioning the washer base 10 under the washing machine 50 so that the central insert 30 fits between the centralized load 58 and the cabinet 52.

In an optional additional step, foam attachments 70 may be securely fitted onto opposing edges 15 of the bottom panel 12.

### INDUSTRIAL APPLICATIONS

The washer base 10 disclosed herein may be used to support components of a washing machine or other large household appliance, particularly the centralized load elements, during assembly, shipping and handling by restricting their movement.

The washer base 10 is capable of supporting the centralized load of an appliance and can travel down any means of conveyance, including a chain, ball, roller or belt conveyor. The washer base 10 can support the centralized load which may be added to the appliance at any point during conveyance.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

1. A washer base for an appliance, the washer base comprising:
a bottom panel having a top surface, the bottom panel defining a bottom opening having a polygonal first perimeter, the bottom panel further comprising bottom flaps hingedly connected to and extending upwardly from the first perimeter; and
a center insert resting on and extending upwardly from the top surface, the center insert having a polygonal bottom rim, a top rim and a sidewall; wherein
the sidewall is affixed to the bottom flaps.

2. The washer base of claim 1 wherein:
the center insert is shaped like a truncated pyramid.

3. The washer base of claim 2 wherein:
the center insert comprises a plurality of sidewall panels.

4. The washer base of claim 3 wherein:
each sidewall panel has a top edge, a bottom edge, and at least one side edge;
at least one sidewall panel has a side edge that is also second free end; and
each sidewall panel is foldably connected to at least one other sidewall panel by the at least one side edge.

5. The washer base of claim 4 wherein:
the first perimeter comprises a number of fold lines joined together at an equal number of first nodes; and
the bottom rim comprises a number of bottom edges joined together at second nodes.

6. The washer base of claim 5 wherein:
the number of sidewall panels is eight; and
the number of fold lines and bottom edges is eight.

7. The washer base of claim 1 wherein:
the number of bottom flaps is eight.

8. The washer base of claim 7 wherein:
the center insert further comprises a glue flap comprising a side edge and a second free end, the glue flap being foldably connected to a sidewall panel by a side edge.

9. The washer base of claim 8 wherein:
the glue flap overlaps a sidewall panel and is adhered thereto.

10. The washer base of claim 1 wherein:
the bottom panel comprises two sets of opposing bottom panel edges.

11. The washer base of claim 10 further comprising:
foam attachments fitted securely onto at least one of the two sets of opposing edges.

12. The washer base of claim 1 wherein:
the top rim has a smaller diameter than the bottom rim.

13. A method of using the washer base of claim 1 comprising the steps of:
(a) providing a washing machine comprising a cabinet affixed to a base, the base defining an opening, the washing machine further comprising a centralized load suspended below a wash tub and within the cabinet; and
(b) positioning the washer base under the washing machine so that the central insert fits between the centralized load and the cabinet.

14. The method of claim 13 comprising the further step of:
securely fitting foam attachments onto opposing edges of the bottom panel.

15. A method of assembling a washer base comprising the steps of:
(a) providing a first blank formed from a substantially rectangular piece of corrugated and having a perimeter defined by four bottom panel edges, the blank comprising a top surface, a bottom opening having an octagonal first perimeter formed from eight fold lines, the blank further comprising a bottom flap hingedly connected to at least two of the fold lines;
(b) providing a second blank having a first free end and a second free end, the second blank comprising eight substantially identical sidewall panels, each sidewall panel having a top edge, a bottom edge, and two side edges 46, each sidewall panel foldably connected to at least one other sidewall panel along a common side edge, one of the sidewall panels having a side edge coinciding with the second free end, the second blank further comprising a glue flap having a top edge, a bottom edge and two side edges, the glue flap foldably connected to a sidewall panel by a common side edge, one of the side edges of the glue flap coinciding with the first free end;
(c) folding the second blank along each side edge to form a truncated eight sided pyramid structure with the glue flap overlapping an adjacent sidewall panel;
(d) adhering the glue flap to the adjacent sidewall panel to form an assembled center insert having a top rim and a bottom rim;
(e) positioning the center insert on top of the first blank so that the bottom rim coincides with the first perimeter;
(f) positioning each bottom flap against a corresponding sidewall panel or against the glue flap; and
(g) adhering each bottom flap to the corresponding sidewall panel or to the glue flap.
